(19) United States
(12) Patent Application Publication
(10) Pub. No.: US 2025/0279843 A1
(43) Pub. Date: Sep. 4, 2025

(54) MONITORING DEVICE, MONITORING METHOD, AND NON-TRANSITORY COMPUTER READABLE MEDIUM

(71) Applicant: Mitsubishi Electric Corporation, Tokyo (JP)

(72) Inventor: Kohei SENGA, Tokyo (JP)

(73) Assignee: Mitsubishi Electric Corporation, Tokyo (JP)

(21) Appl. No.: 19/203,997

(22) Filed: May 9, 2025

Related U.S. Application Data
(63) Continuation of application No. PCT/JP2023/001230, filed on Jan. 17, 2023.

(51) Int. Cl. H04K 3/00; H04W 76/10; H04W 76/30

(52) U.S. Cl. CPC H04K 3/40; H04W 76/10; H04W 76/30; H04K 2203/36

(57) ABSTRACT

A monitoring device (100) includes a communication connection unit (124). The communication connection unit (124) repeatedly executes connection to an unauthorized AP when the unauthorized AP exists in its surroundings, in order to fill simultaneous connection slots of the unauthorized AP, using each device identification information of one or more pieces of device identification information generated not to overlap each other. When connection to the unauthorized AP fails, the communication connection unit (124) connects to the unauthorized AP using device identification information of a damaged CL connected to the unauthorized AP, so as to disconnect communication connection between the unauthorized AP and the damaged CL, and connects to the unauthorized AP using other device identification information, in order to fill vacant simultaneous connection slots of the unauthorized AP that have become available due to disconnection of the communication connection.

### CROSS REFERENCE TO RELATED APPLICATION

This application is a Continuation of PCT International Application No. PCT/JP2023/001230, filed on Jan. 17, 2023, which is hereby expressly incorporated by reference into the present application.

### TECHNICAL FIELD

The present disclosure relates to a monitoring device, monitoring method, and monitoring program.

### BACKGROUND ART

The Wi-Fi (registered trademark) security protocol including up to the security protocol WPA2 (Wi-Fi (registered trademark) Protected Access 2) had a vulnerability where a third party could forcibly disconnect an already established communication using a deauthentication frame, known as a DOS (Denial of Service). In view of this vulnerability, in the security protocol WPA3, countermeasures using a mechanism called PMF (Protected Management Frames) are implemented mandatorily.

Meanwhile, in WIPS (Wireless Intrusion Prevention System), the vulnerability related to the forced disconnection of communication by the deauthentication frame has been used for the purpose of blocking communication of unauthorized devices (including both access points and clients). Fundamental countermeasures against unauthorized devices include physical elimination of the unauthorized devices or cutting off the power supply to the unauthorized devices. However, it is not possible to immediately implement these fundamental countermeasures after detecting unauthorized communication. Therefore, to mitigate damage occurring between the detection of unauthorized communication and the implementation of fundamental countermeasures, forced disconnection of communication using deauthentication frames was employed. However, with the spread of WPA3, forced disconnection of communication using deauthentication frames will no longer function. Therefore, a different method that does not rely on deauthentication frames is needed to block communication of unauthorized devices.

Patent Literature 1 discloses a technology in which, when an unauthorized client is detected in a PMF environment, a WIPS monitoring device impersonates the MAC (Medium Access Control) address of the unauthorized client to connect to authorized access points, thereby updating an encryption key for encrypting communication frames related to the MAC address. As a result of the encryption key being updated, the unauthorized client will not be able to communicate with authorized access points because the unauthorized client does not know the new encryption key.

### CITATION LIST

### Patent Literature

Patent Literature 1: Japanese Patent Publication No. 2018-511282

### SUMMARY OF INVENTION

### Technical Problem

Patent Literature 1 has a problem of not disclosing countermeasures for a case where an unauthorized access point is installed, and a problem of not disclosing countermeasures to make it difficult to reconnect after a communication connection is disconnected.

The present disclosure aims to provide countermeasures for a case where an unauthorized access point is installed in a PMF-enabled Wi-Fi (registered trademark) network so as to prevent easy reconnection after a communication connection is disconnected.

### Solution to Problem

A monitoring device according to the present disclosure includes
a communication connection unit
to repeatedly execute connection to an unauthorized access point when the unauthorized access point exists within a surrounding device group, in order to fill simultaneous connection slots of the unauthorized access point, using each device identification information from a device identification information group consisting of one or more pieces of device identification information generated not to overlap each other;
to connect to the unauthorized access point when the connection to the unauthorized access point fails, using device identification information of a damaged client being a communication device connected to the unauthorized access point, so as to disconnect communication connection between the unauthorized access point and the damaged client; and
to connect to the unauthorized access point using device identification information different from any device identification information in the device identification information group, in order to fill the simultaneous connection slots of the unauthorized access point that have become available due to disconnection of the communication connection,
the surrounding device group consisting of one or more devices that exist around the monitoring device and execute wireless communication,
each device identification information in the device identification information group being different from the device identification information of the damaged client.

### Advantageous Effects of Invention

According to the present disclosure, simultaneous connection slots of an unauthorized access point are filled after disconnecting the communication connection between the unauthorized access point and a damaged client. Therefore, the damaged client cannot easily reconnect to the unauthorized access point after the communication connection is disconnected. Moreover, the present disclosure functions even in a PMF-enabled Wi-Fi (registered trademark) network. Therefore, according to the present disclosure, it is possible to provide a countermeasure in a case where an unauthorized access point is installed in a PMF-enabled Wi-Fi (registered trademark) network, in order to prevent easy reconnection after the communication connection is disconnected.

### BRIEF DESCRIPTION OF DRAWINGS

FIG. 1 is a diagram describing a wireless communication network according to Embodiment 1.

FIG. 2 is a diagram showing a configuration example of a monitoring device 100 according to Embodiment 1.

FIG. 3 is a diagram showing a hardware configuration example of the monitoring device 100 according to Embodiment 1.

FIG. 4 is a flowchart showing the operation of the monitoring device 100 according to Embodiment 1.

FIG. 5 is a diagram showing a hardware configuration example of a monitoring device 100 according to a modification of Embodiment 1.

FIG. 6 is a diagram showing a configuration example of a monitoring device 100 according to Embodiment 2.

FIG. 7 is a flowchart showing the operation of the monitoring device 100 according to Embodiment 2.

FIG. 8 is a flowchart showing the operation of a monitoring device 100 according to a modification of Embodiment 2.

FIG. 9 is a diagram showing a configuration example of a monitoring device 100 according to Embodiment 3.

FIG. 10 is a flowchart showing the operation of the monitoring device 100 according to Embodiment 3.

FIG. 11 is a diagram showing a configuration example of a monitoring device 100 according to Embodiment 4.

FIG. 12 is a flowchart showing the operation of the monitoring device 100 according to Embodiment 4.

FIG. 13 is a diagram showing a configuration example of a monitoring device 100 according to a modification of Embodiment 4.

FIG. 14 is a flowchart showing the operation of the monitoring device 100 according to the modification of Embodiment 4.

FIG. 15 is a diagram showing a configuration example of a monitoring device 100 according to Embodiment 5.

FIG. 16 is a flowchart showing the operation of the monitoring device 100 according to Embodiment 5.

FIG. 17 is a diagram describing a wireless communication network according to the modification of Embodiment 4 and a modification of Embodiment 5.

### DESCRIPTION OF EMBODIMENTS

In the description and drawings of the Embodiment, the same reference numerals are assigned to the same elements and corresponding elements. The description of elements with the same reference numerals is omitted or simplified as appropriate. Arrows in diagrams mainly indicate flows of data or flows of processing. Also, the term “unit” may be appropriately replaced with “circuit”, “stage”, “procedure”, “processing”, or “circuitry”.

### Embodiment 1

Hereinafter, the present Embodiment will be described in detail with reference to the drawings.

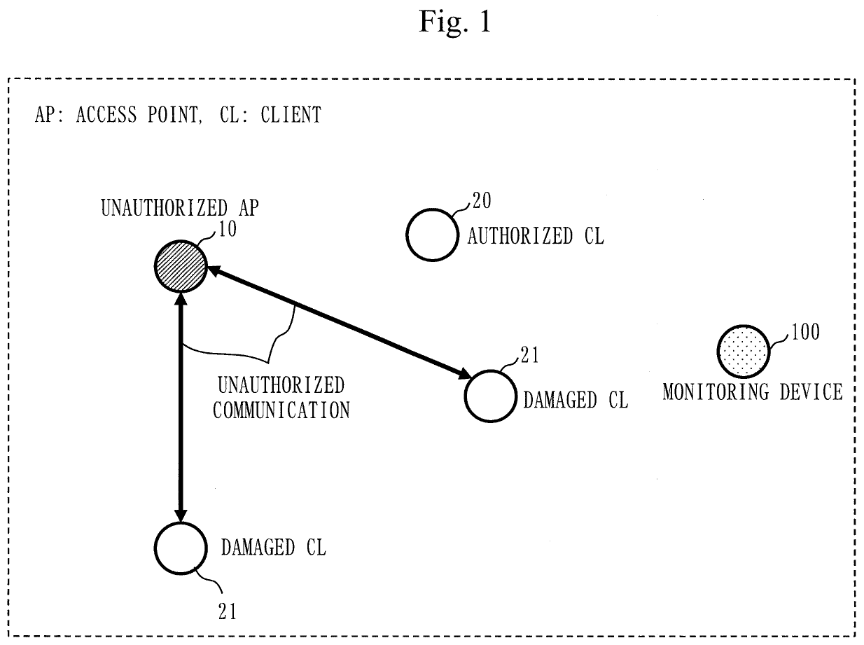

In this Embodiment, the countermeasure against the unauthorized access point is a countermeasure in a situation where, as shown in FIG. 1, an unauthorized AP (access point) 10 has intruded into a wireless communication network and a communication connection has already been established between the unauthorized AP 10 and authorized CLs (clients) 20. The wireless communication network is, as a specific example, a Wi-Fi (registered trademark) network where PMF (Protected Management Frames) is enabled. The authorized CL 20 is a communication device, specifically a communication terminal such as a smartphone and a PC (Personal Computer). Here, among the authorized CLs 20, a CL that has already established a communication connection with the unauthorized AP 10 is particularly called a damaged CL 21. The damaged CL 21 is a communication device connected to the unauthorized AP 10. Also, the communication between the damaged CL 21 and the unauthorized AP 10 is called unauthorized communication. In unauthorized communication, PMF may be enabled, and there is a risk that, for example, the information of the damaged CL 21 may be stolen by the unauthorized AP 10, or the damaged CL 21 may be forced to download malware from the unauthorized AP 10.

In this Embodiment, a countermeasure that a monitoring device 100 can implement in the aforementioned situation is shown. The monitoring device 100 may be at least a part of an authorized AP 30, or may be a device installed independently of the authorized AP 30. Also, when the monitoring device 100 is at least a part of the authorized AP 30, the authorized AP 30 may be equipped with multiple wireless devices, and the operation as an AP and the countermeasure shown in this Embodiment may be implemented by distributing the operation and the countermeasure in the multiple wireless devices.

### ***Description of Configuration***

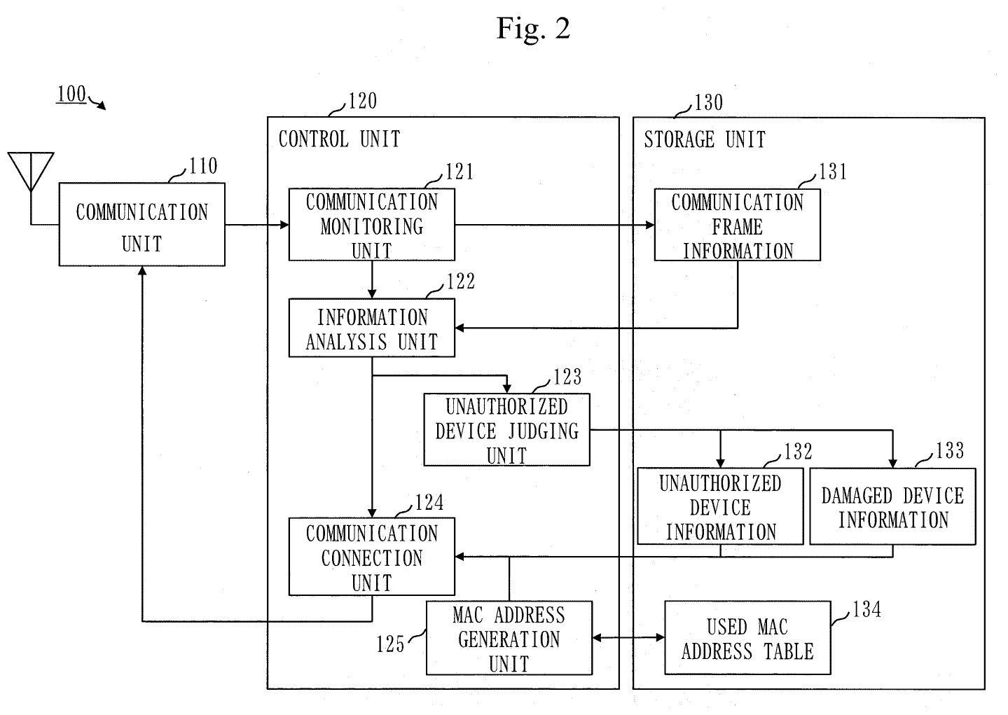

FIG. 2 shows an example configuration of the monitoring device 100 according to Embodiment 1. The monitoring device 100, as shown in FIG. 2, includes a communication unit 110, a control unit 120, and a storage unit 130. The monitoring device 100 is also referred to as a wireless intrusion prevention device. In addition, when the monitoring device 100 is implemented in the authorized AP 30, the monitoring device 100 may further include a communication processing unit that realizes functions as an access point.

The communication unit 110 includes an antenna for wireless communication and has the function of sending and receiving data via wireless communication to and from other devices.

The control unit 120 includes a communication monitoring unit 121, an information analysis unit 122, an unauthorized device judging unit 123, a communication connection unit 124, and a MAC (Medium Access Control) address generation unit 125.

The communication monitoring unit 121 acquires communication frames from each device in a surrounding device group. Here, the surrounding device group consists of one or more devices that exist around the monitoring device 100 and execute wireless communication. The surrounding device group includes at least any one of an unauthorized AP 10, an authorized CL 20, and a damaged CL 21.

The information analysis unit 122 analyzes the communication frames acquired by the communication monitoring unit 121.

The unauthorized device judging unit 123 judges whether each device in the surrounding device group is an unauthorized device. As a specific example, the unauthorized device judging unit 123 judges whether an unauthorized AP 10 exists within the surrounding device group based on a communication frame sent by each device in the surrounding device group.

The communication connection unit 124 executes the process to connect with other devices via wireless communication. In this specification, the term “connection” primarily refers to association via wireless communication.

Below, a specific example of the process of the communication connection unit 124 is described. In this example, PMF may be enabled in wireless communication between the unauthorized AP 10 and the damaged CL 21.

First, the communication connection unit 124 repeatedly executes connection to an unauthorized AP 10 when the unauthorized AP 10 exists within the surrounding device group, in order to fill the simultaneous connection slots of the unauthorized AP 10, using each device identification information from a device identification information group. Here, the device identification information group consists of one or more pieces of device identification information generated not to overlap each other. Also, each device identification information in the device identification information group is different from device identification information of the damaged CL 21. Each device identification information is, as a specific example, a MAC address.

Next, the communication connection unit 124 connects to the unauthorized AP 10 when the connection to the unauthorized AP 10 fails, using the device identification information of the damaged CL 21, so as to disconnect the communication connection between the unauthorized AP 10 and the damaged CL 21.

Then, the communication connection unit 124 connects to the unauthorized AP 10 using device identification information different from any device identification information in the device identification information group, in order to fill the simultaneous connection slots of the unauthorized AP 10 that have become available due to disconnection of the communication connection.

The MAC address generation unit 125 generates MAC addresses as needed.

The storage unit 130 stores communication frame information 131, unauthorized device information 132, damaged device information 133, and a used MAC address table 134.

The communication frame information 131 consists of communication frames sent by the individual devices in the surrounding device group.

The unauthorized device information 132 consists of device information of the individual unauthorized devices. An unauthorized device is a device that is not an authorized device. The unauthorized device may be a device not registered in a list indicating authorized devices, or a device registered in a list indicating unauthorized devices.

The damaged device information 133 consists of device information of the individual damaged devices. A damaged device is a device that is connected to an unauthorized device.

The used MAC address table 134 is table data indicating a list of MAC addresses that have been used.

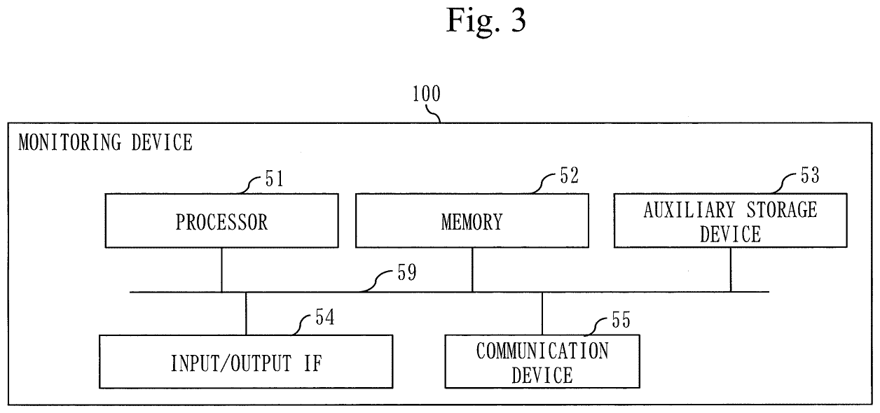

FIG. 3 shows a hardware configuration example of the monitoring device 100 according to this Embodiment. The monitoring device 100 consists of a computer. The monitoring device 100 may consist of multiple computers. Additionally, the monitoring device 100 may be configured to incorporate a computer.

The monitoring device 100 is a computer equipped with hardware such as a processor 51, a memory 52, an auxiliary storage device 53, an input/output IF (Interface) 54, and a communication device 55, as shown in this figure. These hardware components are appropriately connected via a signal line 59.

The processor 51 is an IC (Integrated Circuit) that performs arithmetic processing and controls the hardware provided to the computer. The processor 51 is, for example, a CPU (Central Processing Unit), DSP (Digital Signal Processor), or a GPU (Graphics Processing Unit).

The monitoring device 100 may include a plurality of processors as an alternative to the processor 51. The plurality of processors share roles of the processor 51.

The memory 52 is typically a volatile storage device, constituting the storage unit 130, and is, for example, a RAM (Random Access Memory). The memory 52 is also called a main storage device or main memory. Data stored in the memory 52 is saved in the auxiliary storage device 53 as needed.

The auxiliary storage device 53 is typically a non-volatile storage device, also called storage, and is, for example, a ROM (Read Only Memory), an HDD (Hard Disk Drive), or a flash memory. Data stored in the auxiliary storage device 53 is loaded into the memory 52 as needed.

The memory 52 and the auxiliary storage device 53 may be configured integrally.

The input/output IF 54 is a port to which input and output devices are connected. The input/output IF 54 is, for example, a USB (Universal Serial Bus) terminal. The input device is, for example, a keyboard and a mouse. The output device is, for example, a display.

The communication device 55 is a receiver/transmitter. The communication device 55, as a specific example, is a communication chip or NIC (Network Interface Card).

Each part of the monitoring device 100 may appropriately use the input/output IF 54 and the communication device 55 when communicating with other devices, etc.

The auxiliary storage device 53 stores a monitoring program. The monitoring program is a program that enables the function of each part of the monitoring device 100 to be realized on a computer. By the monitoring program stored in the auxiliary storage device 53 being loaded into the memory 52 and executed by the processor 51, the functions of this Embodiment are implemented. The function of each part of the monitoring device 100 is implemented by software.

Data used when executing the monitoring program and data obtained by executing the monitoring program, etc., are appropriately stored in the storage device. Each part of the monitoring device 100 appropriately utilizes the storage device. The storage device consists of at least one of the memory 52, the auxiliary storage device 53, a register within the processor 51, and a cache memory within the processor 51. It should be noted that the term data and the term information may sometimes have equivalent meanings. The storage device may be independent of the computer.

The functions of the memory 52 and auxiliary storage device 53 may be implemented by other storage devices.

The monitoring program may be recorded on a computer readable non-volatile recording medium. As a specific example, the non-volatile recording medium is an optical disc or flash memory. The monitoring program may be provided as a program product.

### ***Description of Operation***

The operation procedure of the monitoring device 100 corresponds to a monitoring method. Additionally, a program that realizes the operation of the monitoring device 100 corresponds to the monitoring program.

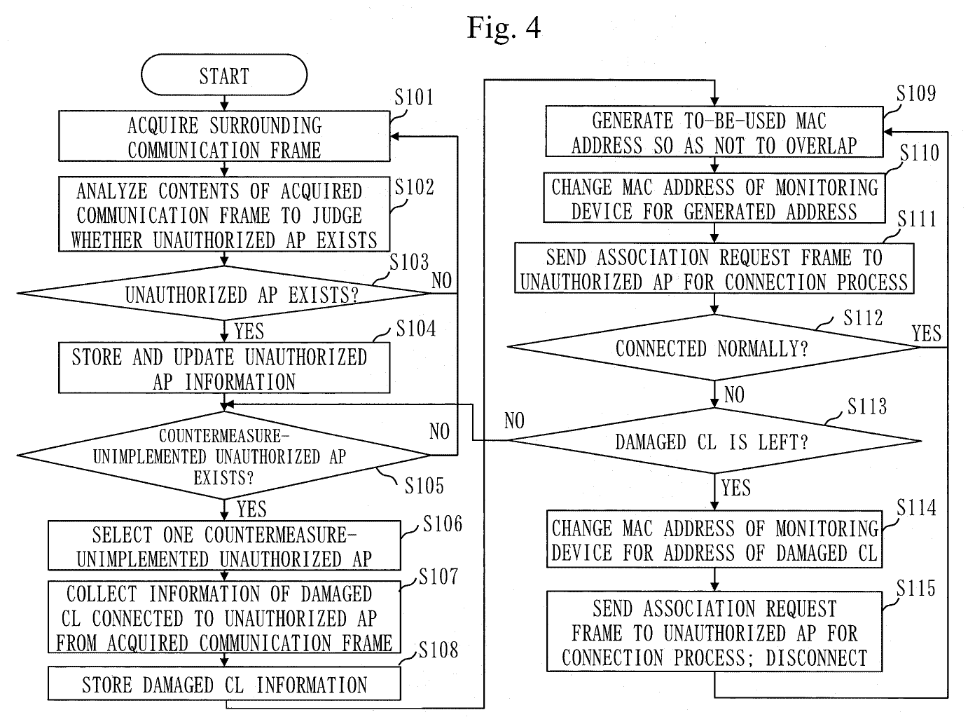

FIG. 4 is a flowchart showing an example of the operation of the monitoring device 100 according to Embodiment 1. FIG. 4 is used to describe the operation of the monitoring device 100 according to Embodiment 1.

### (Step S101)

First, the communication unit 110 receives communication radio waves from each device in the surrounding device group using an antenna, demodulates the received radio waves, and performs analog-digital conversion on the demodulated results to obtain a digital signal.

Next, the communication unit 110 sends the obtained digital signal to the communication monitoring unit 121.

Next, the communication monitoring unit 121 interprets the received digital signal as a communication frame, thereby acquiring a communication frame sent and received by each device in the surrounding device group. The communication monitoring unit 121 stores the acquired communication frame in the storage unit 130 as part of the communication frame information 131.

### (Step S102)

First, the information analysis unit 122 analyzes the communication frame information 131 to acquire information on each device in the surrounding device group. As a specific example, the information of the unauthorized AP 10 is information obtained from a beacon frame that the unauthorized AP 10 sends periodically, indicating at least one of the unauthorized AP 10′s BSSID (Basic Service Set Identifier), ESSID (Extended Service Set Identifier), the channel in use (communication frequency), PMF enabled/disabled, authentication method, encryption method, and MAC address (usually the same as BSSID). Additionally, the information of the authorized CL 20 or the damaged CL 21 is information obtained from a communication frame addressed to an AP or from a probe request frame sent to search for an AP, indicating at least any one of the MAC address of the authorized CL 20 or the damaged CL 21, and the ESSID and BSSID of the AP to which the authorized CL 20 or the damaged CL 21 is connected (or searching).

Next, the unauthorized device judging unit 123 judges whether an unauthorized AP 10 exists in the surrounding device group based on the information acquired by the information analysis unit 122. The method to judge whether an unauthorized AP 10 exists includes, as a specific example, judging that the unauthorized AP 10 exists if a device matching a device on the list of predetermined unauthorized device information is included in the surrounding device group, judging that an unauthorized AP 10 exists if a device not shown in the list of the predetermined authorized device information is included in the surrounding device group, judging that an unauthorized AP 10 exists if a device with the same device information as the monitoring device 100 is included in the surrounding device group, and judging that an unauthorized AP 10 exists if there is an unexpected response (or no response) when accessing an AP indicated by the acquired information via the wired network to which the authorized AP 30 is connected.

### (Step S103)

If an unauthorized AP 10 exists in the surrounding device group, the monitoring device 100 proceeds to step S104. If an unauthorized AP 10 does not exist in the surrounding device group, the monitoring device 100 returns to step S101.

### (Step S104)

The unauthorized device judging unit 123 stores the device information of the unauthorized AP 10 detected in step S102 to the storage unit 130 as part of the unauthorized device information 132. Here, the device information corresponding to each device is assumed to include a countermeasure implementation flag corresponding to each device. The countermeasure implementation flag corresponding to each device is a flag to indicate whether countermeasures have been implemented for each device. When a countermeasure implementation flag corresponding to a certain device is set, this indicates that countermeasures have been implemented for that device. It is possible that an unauthorized AP 10, for which countermeasures have been implemented once, may attempt to attack again after rebooting. Therefore, implementation may be performed such that the countermeasure implementation flag corresponding to each device is reset (to a state indicating countermeasures not implemented) after a specified time has elapsed since the flag was set.

Regarding the unauthorized device information 132, each device information may be deleted after a specified time has elapsed since the device information is added to the unauthorized device information 132, or the unauthorized device information 132 may be reset each time step S104 is executed. Additionally, the unauthorized device judging unit 123 may fix an upper limit on the number of unauthorized APs 10, and if the number of unauthorized APs 10 exceeds the fixed upper limit, the unauthorized device judging unit 123 may delete the oldest device information from the unauthorized device information 132 and then add new device information to the unauthorized device information 132.

### (Step S105)

If there is no device information without a countermeasure implementation flag being set in the unauthorized device information 132 (that is, if a countermeasure implementation flag is set for device information of all the unauthorized APs 10 indicated by the unauthorized device information 132), the monitoring device 100 returns to step S101. Otherwise, the monitoring device 100 proceeds to step S106.

### (Step S106)

The unauthorized device judging unit 123 selects one piece of device information not having a countermeasure implementation flag being set, from the device information of the unauthorized AP 10 indicated by the unauthorized device information 132. Hereafter, the unauthorized AP 10 selected in step S106 is referred to as the selected unauthorized AP.

### (Step S107)

First, the unauthorized device judging unit 123 requires the information analysis unit 122 to acquire the device information of each damaged CL 21 connected to the selected unauthorized AP.

Next, the information analysis unit 122 acquires the device information of each damaged CL 21 connected to the selected unauthorized AP and sends the acquired device information to the unauthorized device judging unit 123.

### (Step S108)

The unauthorized device judging unit 123 stores the device information, sent by the information analysis unit 122, of each damaged CL 21 connected to the selected unauthorized AP, to the storage unit 130 as part of the damaged device information 133. Here, the device information corresponding to each device is assumed to include a countermeasure implementation flag corresponding to that device.

Regarding the damaged device information 133, each device information may be deleted after a specified time has elapsed since the device information is added to the damaged device information 133, or the damaged device information 133 may be reset each time step S108 is executed. Additionally, the unauthorized device judging unit 123 may fix an upper limit on the number of damaged CLs 21, and if the number of damaged CLs 21 exceeds the fixed upper limit, the unauthorized device judging unit 123 may delete the oldest device information from the damaged device information 133 and then add new device information to the damaged device information 133. However, if adopting, among the three methods mentioned above, the two methods other than the method of resetting the damaged device information 133 each time step S108 is executed, there may be multiple pairs of unauthorized AP 10 and damaged CL 21. Therefore, it is necessary to store information indicating the unauthorized AP 10 to which each damaged CL 21 is connected (for example, the BSSID of the unauthorized AP 10), such that the information is linked to each device information.

### (Step S109)

The MAC address generation unit 125 generates one MAC address. The MAC address generation unit 125 may generate the MAC address using a random number, or by incrementing the value of the MAC address indicated by the damaged device information 133. The MAC address generation unit 125 refers to the damaged device information 133 and the used MAC address table to confirm that the generated MAC address is different from any MAC address in a confirmation target MAC address group. The confirmation target MAC address group consists of the MAC addresses of the individual damaged CLs 21 and the MAC addresses stored in the used MAC address table.

The MAC address generation unit 125, upon confirming that the generated MAC address is different from any MAC address in the confirmation target MAC address group, adds the generated MAC address to the used MAC address table 134 and sends data indicating the generated MAC address to the communication connection unit 124. If the generated MAC address overlaps any MAC address in the confirmation target MAC address group, the MAC address generation unit 125 regenerates the MAC address and then reconfirms that the newly generated MAC address is different from any MAC address in the confirmation target MAC address group.

Here, if the generated MAC addresses are continuously stored permanently in the used MAC address table 134, there is a possibility of falling into an endless loop of MAC address generation and confirmation failure due to MAC address exhaustion. Therefore, each MAC address stored in the used MAC address table 134 may be deleted after a specified time has elapsed since it is added to the used MAC address table 134, or the used MAC address table 134 may be reset each time step S106 is executed. Additionally, the MAC address generation unit 125 may fix an upper limit on the number of MAC addresses that can be stored, and if the number of MAC addresses exceeds the fixed upper limit, the MAC address generation unit 125 may delete the oldest MAC address from the used MAC address table 134 and then store a new MAC address in the used MAC address table 134.

### (Step S110)

The communication connection unit 124 generates a communication frame necessary for a connection process as a digital signal. At this time, the communication connection unit 124 sets the MAC address generated in step S109, as the transmission source MAC address.

### (Step S111)

The communication connection unit 124 executes the connection process by sending an authentication request frame and an association request frame, etc., to the unauthorized AP 10 via the communication unit 110. The communication connection unit 124 confirms that the connection process is executed normally by checking the response from the communication unit 110. If encryption of communication is set, the communication connection unit 124 may proceed with the connection process up to sharing of the encryption key.

### (Step S112)

If the monitoring device 100 can connect normally to the unauthorized AP 10, the monitoring device 100 returns to step S109.

If the monitoring device 100 cannot connect normally to the unauthorized AP 10, it is determined that the maximum number of simultaneous connections to the unauthorized AP 10 has been reached, and the monitoring device 100 proceeds to step S113. If the monitoring device 100 cannot connect normally to the unauthorized AP 10, specifically, this is when an error is returned, or when the monitoring device 100 cannot connect normally to the unauthorized AP 10 because communication timeout occurs, etc.

### (Step S113)

If there is no device information without a countermeasure implementation flag being set in the damaged device information 133 (i.e., if the countermeasure implementation flag is set for device information of all the damaged CL 21 indicated by the damaged device information 133), the unauthorized device judging unit 123 sets the countermeasure implementation flag in the device information of the selected unauthorized AP in the unauthorized device information 132, judging that countermeasures have been implemented for the selected unauthorized AP, and then the monitoring device 100 returns to step S105. Otherwise, the monitoring device 100 proceeds to step S114.

### (Step S114)

The communication connection unit 124 generates a communication frame necessary for the connection process as a digital signal. At this time, the communication connection unit 124 refers to the damaged device information 133 to select one damaged CL 21 for which countermeasures have not been implemented, and sets the MAC address of the selected damaged CL 21, as the transmission source MAC address of the communication frame. Here, the damaged CL 21 for which countermeasures have not been implemented corresponds to the damaged CL 21 among the device information included in the damaged device information 133, where the countermeasure implementation flag is not set. Hereinafter, the damaged CL 21 selected in step S114 will be referred to as the first selected damaged CL.

### (Step S115)

The communication connection unit 124 executes the connection process by sending an authentication request frame and an association request frame, etc., to the unauthorized AP 10 via the communication unit 110. The communication connection unit 124 confirms that the connection process has been executed normally by checking the response from the communication unit 110. If encryption of communication is set, the communication connection unit 124 proceeds with the connection process up to the sharing of the encryption key.

Once the connection process with the unauthorized AP 10 is completed, the communication connection unit 124 sends a deauthentication frame in which the transmission source MAC address is set as the MAC address of the first selected damaged CL, to the unauthorized AP 10, thereby disconnecting the communication connection between the unauthorized AP 10 and the first selected damaged CL. Here, in a case where communication encryption is set, since the monitoring device 100 can obtain the communication encryption key by proceeding with the sharing process of the encryption key, the unauthorized AP 10 can be made to process the deauthentication frame normally even if PMF is enabled.

In cases where communication encryption is set, depending on the implementation of the unauthorized AP 10, it may be possible to disconnect the communication connection between the unauthorized AP 10 and the first selected damaged CL by simply sending a deauthentication frame with the transmission source MAC address being set as the MAC address of the first selected damaged CL, to the unauthorized AP 10 during the connection process, without proceeding with the connection process up to the sharing of the encryption key.

Through the aforementioned process, unauthorized communication between the first selected damaged CL and the unauthorized AP 10 is disconnected. The communication connection unit 124 sets, in the damaged device information 133, a countermeasure implementation flag in the device information of the first selected damaged CL in order to record that the unauthorized communication has been disconnected.

Meanwhile, the disconnection of the communication connection frees up one slot in the simultaneous connection capacity of the unauthorized AP 10. To prevent the damaged CL 21 from reconnecting to the freed slot, the monitoring device 100 returns to step S109 after executing step S115.

### ***Explanation of the Effects of Embodiment 1***

As described above, in this Embodiment, unauthorized communication between the damaged CL 21 and the unauthorized AP 10 is disconnected. Furthermore, since the monitoring device 100 fills the simultaneous connection slots of the unauthorized AP 10, the damaged CL 21, whose unauthorized communication has been disconnected, cannot reconnect to the unauthorized AP 10. Therefore, according to this Embodiment, it is possible to mitigate damages such as the information of the damaged CL 21 being stolen by the unauthorized AP 10 or the damaged CL 21 being forced to download malware from the unauthorized AP 10. Additionally, according to this Embodiment, it is possible to buy time needed until fundamental countermeasures such as the physical elimination of unauthorized devices or cutting off the power to unauthorized devices are implemented.

### ***Other Configurations***

### <Modification 1>

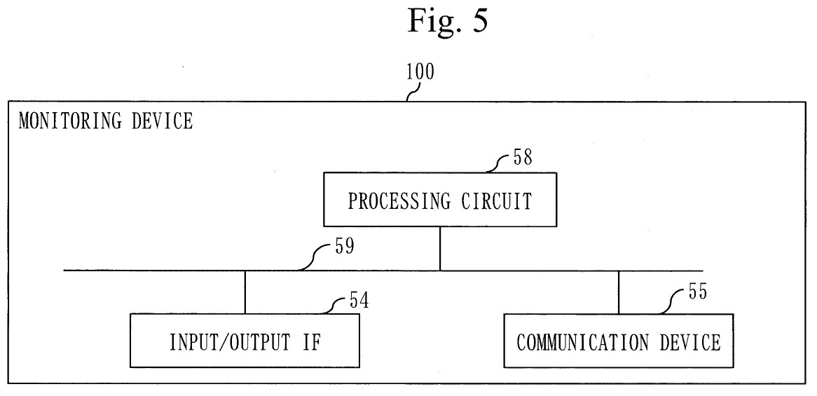

FIG. 5 shows a hardware configuration example of a monitoring device 100 according to this modification.

The monitoring device 100, instead of: the processor 51; the processor 51 and the memory 52; the processor 51 and the auxiliary storage device 53; or the processor 51, the memory 52, and the auxiliary storage device 53, includes a processing circuit 58. The processing circuit 58 is hardware that realizes at least part of the components provided to the monitoring device 100.

The processing circuit 58 may be dedicated hardware, or a processor that executes a program stored in the memory 52.

When the processing circuit 58 is dedicated hardware, the processing circuit 58 may be, for example, a single circuit, a composite circuit, a programmed processor, a parallel-programmed processor, an ASIC (Application Specific Integrated Circuit), an FPGA (Field Programmable Gate Array), or a combination of these.

The monitoring device 100 may include a plurality of processing circuits as an alternative to the processing circuit 58. The plurality of processing circuits share the role of the processing circuit 58.

In the monitoring device 100, some functions may be implemented by dedicated hardware, and the remaining functions may be implemented by software or firmware.

The processing circuit 58 may be implemented by hardware, software, firmware, or a combination of these, as a specific example.

The processor 51, the memory 52, the auxiliary storage device 53, and the processing circuit 58 are collectively referred to as “processing circuitry”. In other words, the functions of the individual functional components of the monitoring device 100 are implemented by the processing circuitry.

A monitoring device 100 according to another Embodiment may also have the same configuration as this modification.

### Embodiment 2

Below, the points differing from the aforementioned Embodiment will mainly be described with reference to the drawings.

In Embodiment 1, when a large number of the damaged CLs 21 exist, it may require a certain amount of time to implement countermeasures for all the damaged CLs 21. Therefore, in Embodiment 2, a mode is shown where the damaged CL 21 is retreated to another channel as preparation on ahead before filling the simultaneous connection slots of the unauthorized AP 10.

### ***Description of Configuration***

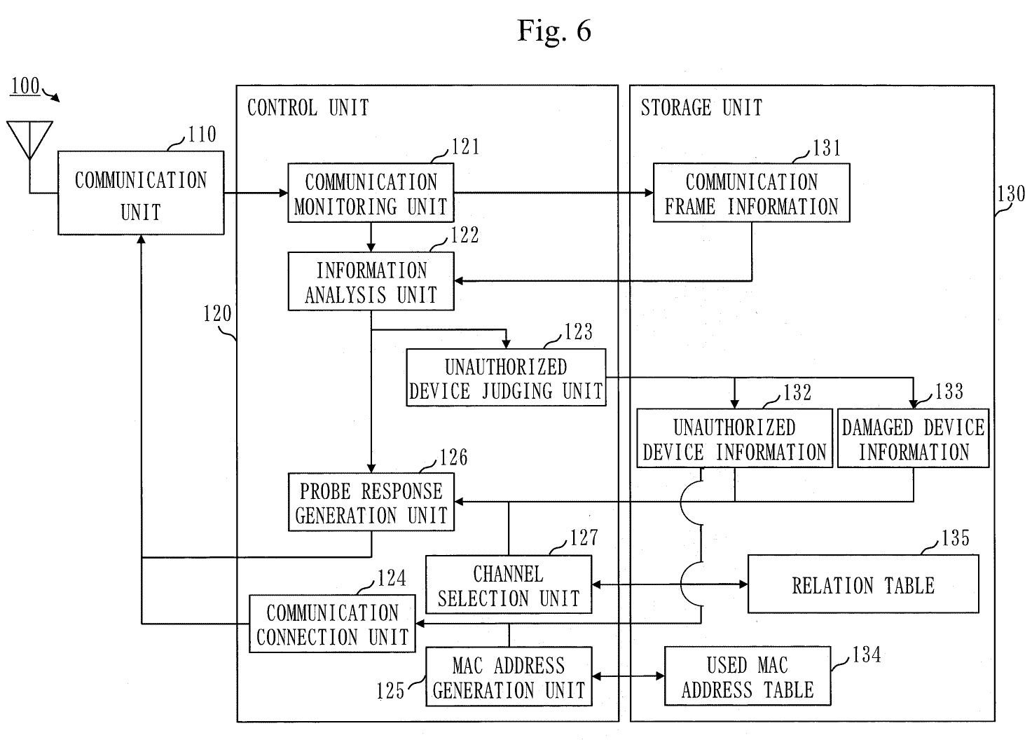

FIG. 6 shows a configuration example of a monitoring device 100 according to Embodiment 2.

A control unit 120 according to Embodiment 2, as shown in FIG. 6, further includes a probe response generation unit 126 and a channel selection unit 127 when compared to the control unit 120 according to Embodiment 1.

The probe response generation unit 126 generates a communication frame including information to switch the channel of a damaged CL 21 to a channel selected by the channel selection unit 127. The communication frame is, as a specific example, a beacon frame or a probe response frame.

As a specific example, the probe response generation unit 126 sends first transmission data to the damaged CL 21 so as to switch the channel of the damaged CL 21 to a first channel. The first transmission data is communication data including: a communication frame in which device identification information of the unauthorized AP 10 is set as source device identification information so that the monitoring device 100 is recognized as an unauthorized AP 10; and a communication frame in which the first channel is set as a channel to switch to. The first channel is a channel where an unauthorized AP 10 does not exist. It should be noted that setting the device identification information of the unauthorized AP 10 as the source device identification information so that the monitoring device 100 is recognized as the unauthorized AP 10 corresponds to the monitoring device 100 impersonating the unauthorized AP 10.

The channel selection unit 127 selects a channel where an unauthorized AP 10 does not exist, as a channel switching destination of the damaged CL 21.

The storage unit 130 according to Embodiment 2, as shown in FIG. 6, further

stores a relation table 135 when compared to the storage unit 130 according to Embodiment 1.

The relation table 135 is table data indicating pairs each consisting of an individual damaged device and a channel where the damaged device exists, and is also called a “relation table of damaged devices and channels”.

### ***Description of Operation***

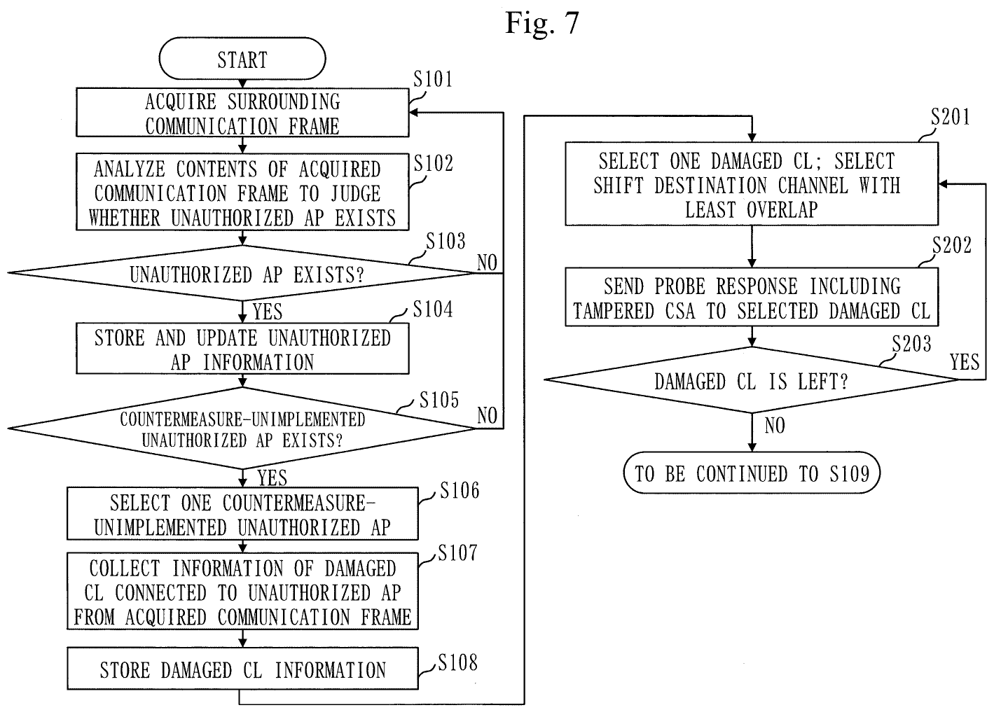

FIG. 7 is a flowchart showing an example of the operation of the monitoring device 100 according to Embodiment 2. Using FIG. 7, the operation of the monitoring device 100 according to Embodiment 2 is described.

### (Step S201)

First, the channel selection unit 127 refers to damaged device information 133 and selects one damaged CL 21 for which countermeasures have not been implemented. Hereinafter, the damaged CL 21 selected in step S201 is referred to as a second selected damaged CL.

Next, the channel selection unit 127 refers to the relation table 135 and selects one channel as the destination channel to which the second selected damaged CL is to shift, where an unauthorized AP 10 does not exist and the number of related damaged CLs 21 is minimal. If there are multiple of such channels, the channel selection unit 127 may select a channel with the smallest channel number or use a random number to select the channel. Hereinafter, the channel selected in step S201 is referred to as a first selected channel. If an unauthorized AP 10 exists on all channels, there is no effect in shifting the second selected damaged CL to another channel, so the monitoring device 100 terminates the process of step S201 and proceeds to step S109.

Next, the channel selection unit 127 adds a pair of the second selected damaged CL and the first selected channel to the relation table 135. Additionally, the channel selection unit 127 sends data indicating the pair of the second selected damaged CL and the first selected channel to the probe response generation unit 126.

### (Step S202)

CSA (Channel Switch Announcement) is information sent to the CL when switching the channel through which the AP communicates. CSA is included in the beacon frame or the probe response frame, etc.

The probe response generation unit 126 sets the MAC address of the sender as the MAC address of the unauthorized AP 10, and sends a probe response frame in which the first selected channel is set as the destination channel for switching in the CSA, to the second damaged CL via the communication unit 110. Changing the content of the CSA corresponds to tampering with the CSA.

After the transmission is completed, the probe response generation unit 126 sets a countermeasure implementation flag in the device information of the second damaged CL in the damaged device information 133 to record that the channel has been switched. When the damaged CL 21 is shifted to a channel different from the unauthorized AP 10, the unauthorized AP 10 can no longer communicate with the damaged CL 21, so it is permissible to share the flag indicating the channel switching and the countermeasure implementation flag. Note that channel switching corresponds to channel hopping.

### (Step S203)

If there is no device information without a countermeasure implementation flag being set in the damaged device information 133 (i.e., if the countermeasure implementation flag is set for device information of all the damaged CLs 21 indicated by the damaged device information 133), the monitoring device 100 proceeds to step S109 to fill the simultaneous connection slots of the unauthorized AP 10. Otherwise, the monitoring device 100 proceeds to step S201.

### ***Explanation of the Effects of Embodiment 2***

As described above, in this Embodiment, by switching the channel before filling the simultaneous connection slots of the unauthorized AP 10, unauthorized communication between the damaged CL 21 and the unauthorized AP 10 is disconnected.

Furthermore, by filling the simultaneous connection slots of the unauthorized AP 10, the disconnected damaged CL 21 will not reconnect to the unauthorized AP 10. Additionally, according to this Embodiment, effects similar to those of Embodiment 1 can be obtained.

Moreover, in Embodiment 1, since the process of filling the simultaneous connection slots of the unauthorized AP 10 is executed on ahead, it requires time to disconnect the unauthorized communication between the damaged CL 21 and the unauthorized AP 10. However, according to this Embodiment, since it is possible to disconnect the unauthorized communication before executing the process of filling the simultaneous connection slots of the unauthorized AP 10, the damage can be mitigated more compared to Embodiment 1.

### ***Other Configurations***

### <Modification 2>

In Embodiment 2, the damaged CL 21 is shifted to a channel determined randomly. If there is no authorized AP 30 at the shift destination, the shifted damaged CL 21 cannot communicate at all. Therefore, in this modification, assuming the presence of multiple wireless devices, authorized communication and countermeasures against the unauthorized AP 10 are implemented in parallel. Here, the authorized AP 30 may have multiple wireless devices, leading to the presence of multiple wireless devices. Each of the authorized AP 30 and the monitoring device 100, being independent of the authorized AP 30, may have one or more wireless devices, leading to the presence of multiple wireless devices.

This modification indicates a mode where, after executing the process of step S203, before executing the process of step S109, the damaged CL 21, which has been shifted to another channel, is shifted back to the channel of the authorized AP 30, so while authorized communication is conducted with one wireless device, the simultaneous connection slots of the unauthorized AP 10 are filled with another wireless device.

Below, the points different from Embodiment 2 are mainly described.

### ***Description of Configuration***

The configuration of a monitoring device 100 according to this modification is the same as the configuration of the monitoring device 100 according to Embodiment 2.

When the monitoring device 100 functions as an authorized AP 30, a probe response generation unit 126 according to this modification sends second transmission data to a damaged CL 21 whose channel has been switched to a first channel, so as to switch the channel of the damaged CL 21 to a second channel. The second transmission data is communication data including: a communication frame in which the device identification information of the unauthorized AP 10 is set as the source device identification information so that the monitoring device 100 is recognized as an unauthorized AP 10; and a communication frame in which the second channel is set as a channel switching destination. The second channel is a channel where an unauthorized AP 10 does not exist. After that, the probe response generation unit 126 switches a channel of the monitoring device 100 to the second channel to establish authorized communication for the damaged CL 21.

### ***Description of Operation***

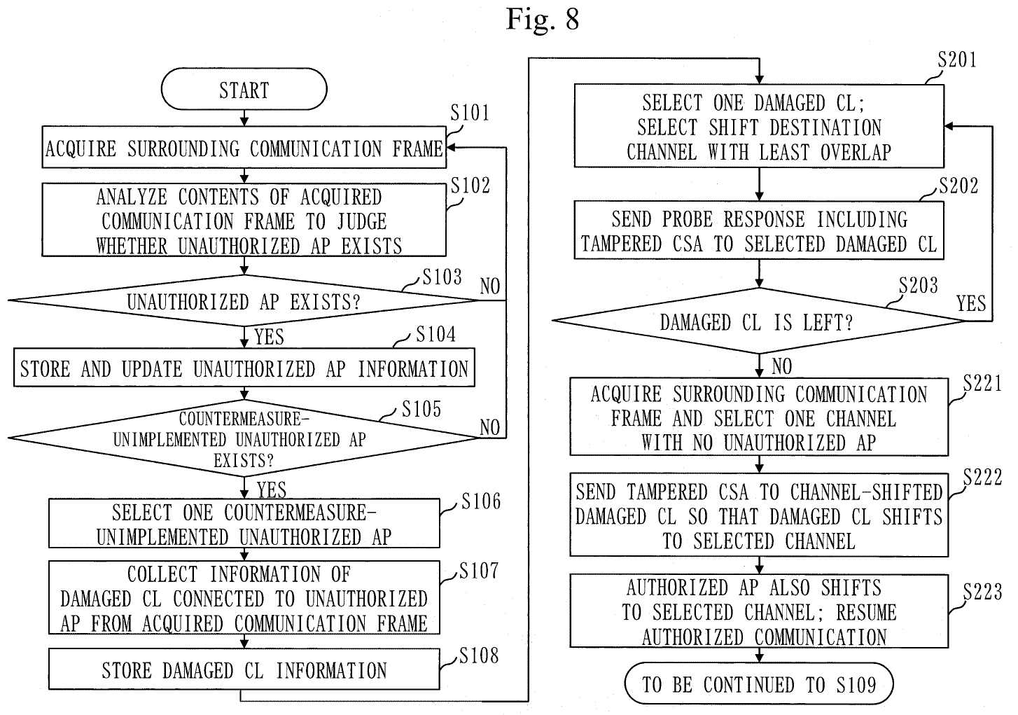

FIG. 8 is a flowchart showing an example of the operation of the monitoring device 100 according to this modification. Using FIG. 8, the operation of the monitoring device 100 is described.

### (Step S221)

The channel selection unit 127 selects one channel where an unauthorized AP 10 does not exist, as the channel to resume authorized communication. Hereafter, the channel selected in step S221 is referred to as a second selected channel.

However, in this modification, assuming the possibility that the unauthorized AP 10 may perform channel shifting following the CSA sent in step S202, the channel selection unit 127 reacquires surrounding communication frames before selecting a channel, and confirms the channel where the unauthorized AP 10 exists based on the acquired communication frames.

### (Step S222)

The probe response generation unit 126 sequentially sets the source MAC address as the MAC address of the unauthorized AP 10, and sends a probe response frame in which the second selected channel is set as the channel to switch to in the CSA, to the damaged CL 21 indicated by the relation table 135, via the communication unit 110.

At the time of sending the probe response frame, the monitoring device 100 that sends the probe response frame needs to shift to a channel where the damaged CL 21, being the destination of the probe response frame, exists.

### (Step S223)

The probe response generation unit 126 shifts the channel of the authorized AP 30 to the second selected channel and sends the probe response frame to the damaged CL 21 as the authorized AP 30. As a result, the damaged CL 21 can connect with the authorized AP 30 and resume authorized communication.

Meanwhile, the wireless device responsible for filling the simultaneous connection slots of the unauthorized AP 10 shifts its channel to the channel where an unauthorized AP 10 exists, and proceeds to step S109 to continue processing.

### ***Explanation of the Effects of Modification 2***

In Embodiment 2, the damaged CL 21 is shifted to a randomly determined channel. If an authorized AP 30 does not exist at the destination, the shifted damaged CL 21 cannot communicate at all. However, according to this modification, it is possible to simultaneously implement communication between the authorized AP 30 and the authorized CL 20 and countermeasures against the unauthorized AP 10.

### Embodiment 3

Hereafter, the points differing from the aforementioned Embodiments will mainly be described with reference to the drawings.

In Embodiment 1 and Embodiment 2, it is necessary to implement countermeasures for the damaged CLs 21 one by one, which requires a relatively long time to implement. Embodiment 3 shows a mode in which when there are many damaged CLs 21, damage is mitigated by obstructing unauthorized communication more quickly.

### ***Description of Configuration***

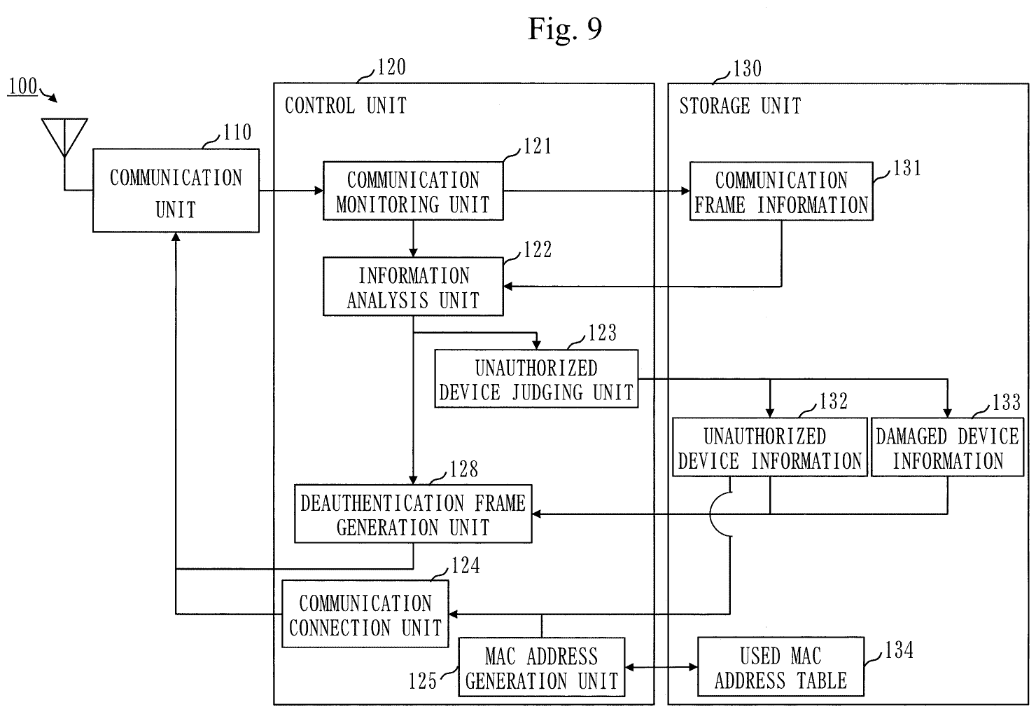

FIG. 9 illustrates an example configuration of a monitoring device 100 according to Embodiment 3.

As shown in FIG. 9, a control unit 120 according to Embodiment 3, when compared to the control unit 120 according to Embodiment 1, further includes a deauthentication frame generation unit 128.

The deauthentication frame generation unit 128 generates a deauthentication frame using an encryption key received from an unauthorized AP 10 when PMF is enabled in wireless communication between the unauthorized AP 10 and the damaged CL 21, and sends communication data including the generated deauthentication frame to the damaged CL 21. The encryption key is a common key in a wireless communication network to which the unauthorized AP 10 is participating.

### ***Description of Operation***

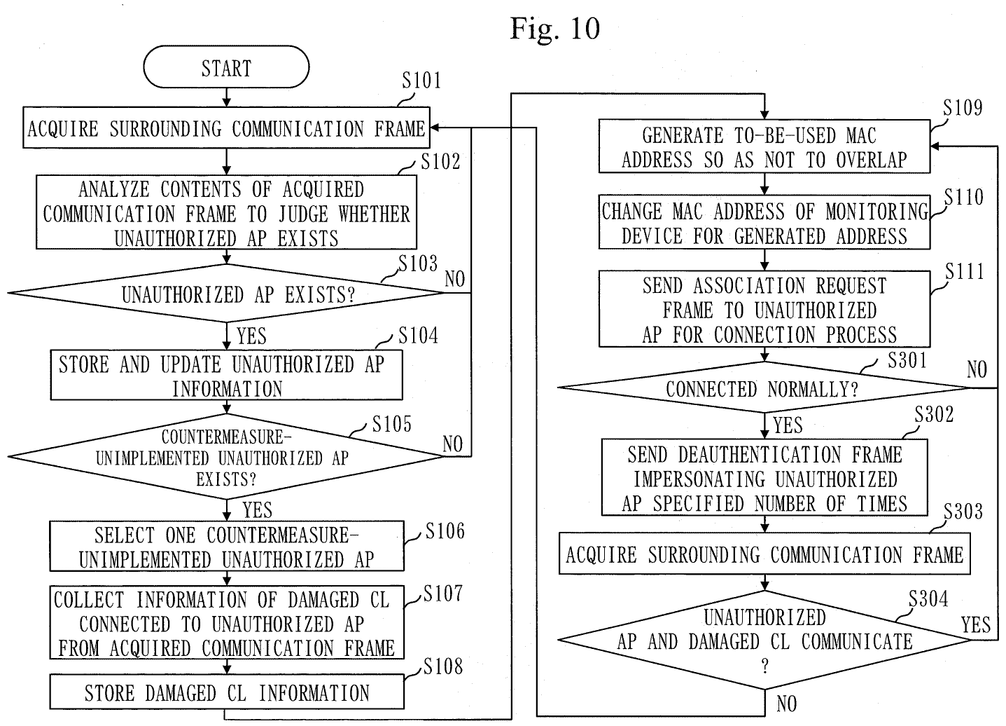

FIG. 10 is a flowchart showing an example of the operation of the monitoring device 100 according to Embodiment 3. The operation of the monitoring device 100 is described using FIG. 10.

### (Step S301)

If the monitoring device 100 can successfully connect to the unauthorized AP 10, the monitoring device 100 proceeds to step S302.

If the monitoring device 100 cannot successfully connect to the unauthorized AP 10, the monitoring device 100 returns to step S109.

### (Step S302)

The deauthentication frame generation unit 128 sends a deauthentication frame in which the source MAC address is set as the MAC address of the unauthorized AP 10, to the wireless communication network in which the selected unauthorized AP is participating, by broadcasting within the LAN (Local Area Network) of the selected unauthorized AP a specified number of times. Broadcast communication in PMF is protected by BIP (Broadcast Integrity Protocol). Here, an IGTK (Integrity Group Transient Key), being an encryption key common within the LAN received from the AP, is used for integrity verification of the broadcast communication frame in BIP. Therefore, by the monitoring device 100 successfully connecting to the unauthorized AP 10 as a CL and receiving the IGTK, and using the received IGTK to send a broadcast deauthentication frame impersonating the unauthorized AP 10, it is possible to disconnect the communication between the unauthorized AP 10 and the damaged CL 21 within the LAN in which the unauthorized AP 10 is participating. Setting the source MAC address to the MAC address of the unauthorized AP 10 corresponds to impersonating the unauthorized AP 10.

### (Step S303)

First, a communication monitoring unit 121 acquires communication frames from devices in a surrounding device group via a communication unit 110.

Next, an information analysis unit 122 checks whether there is a communication frame from the selected unauthorized AP (i.e., a communication frame with the MAC address of the selected unauthorized AP as the source) among the communication frames acquired by the communication monitoring unit 121.

In step S303, the communication monitoring unit 121 and the information analysis unit 122 appropriately execute at least part of step S101 and step S102.

### (Step S304)

If there is a communication frame between the selected unauthorized AP and the damaged CL 21, it suggests that the communication has not been properly disconnected, or that the damaged CL 21 has reconnected to the selected unauthorized AP after the communication was properly disconnected, so the monitoring device 100 returns to step S109.

If there is no communication frame from the selected unauthorized AP, the monitoring device 100 returns to step S101.

### ***Description of Effects of Embodiment 3***

As described above, according to this Embodiment, it is possible to disrupt unauthorized communication between the damaged CL 21 and the unauthorized AP 10 using a deauthentication frame. Additionally, according to this Embodiment, it is possible to achieve effects similar to those of Embodiment 1.

### Embodiment 4

Below, differences from the previously described Embodiment will mainly be described with reference to the drawings.

In Embodiment 3, there is a problem that if the unauthorized AP 10 has very high processing capability, a function as a disruption might not be achieved because the load on the unauthorized AP 10 cannot be sufficiently increased. Therefore, in Embodiment 4, a mode is shown where unauthorized communication is disrupted by having the damaged CL 21 restrain from communicating with the unauthorized AP 10, instead of executing disruption on the unauthorized AP 10.

### ***Description of Configuration***

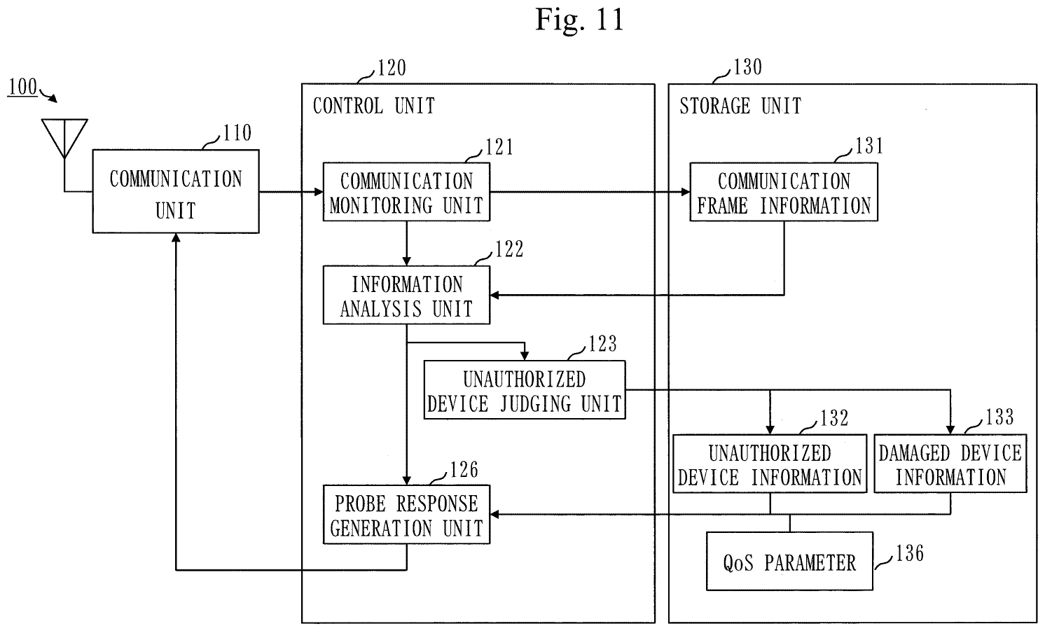

FIG. 11 shows an example configuration of a monitoring device 100 according to Embodiment 4.

A control unit 120 according to Embodiment 4, as shown in FIG. 11, is equipped with a probe response generation unit 126 instead of a communication connection unit 124 and a MAC address generation unit 125.

The probe response generation unit 126 according to this Embodiment generates a beacon frame or a probe response frame.

As a specific example, the probe response generation unit 126 sends fourth transmission data to a damaged CL 21 to extend the time until the damaged CL 21 communicates next. The fourth transmission data is communication data including: a communication frame in which device identification information of an unauthorized AP is set as source device identification information so that the monitoring device 100 is recognized as the unauthorized AP 10; and a communication frame in which either a QoS (Quality of Service) related field or a field related to communication control is set so that a waiting time taken until the damaged CL 21 sends a communication frame to the unauthorized AP 10 is not shorter than a first reference waiting time. The first reference waiting time may be defined in any manner.

The storage unit 130 according to Embodiment 4 stores a QoS parameter 136 instead of the used MAC address table 134, as shown in FIG. 11.

The QoS parameter 136 in Embodiment 4 is a value of the QoS related field in the IEEE (Institute of Electrical and Electronics Engineers) 802.11 frame format. As a specific example, the QoS parameter 136 expresses the EDCA (Enhanced Distributed Channel Access) parameter's CWmin (Contention Windows minimum; the minimum value of the communication waiting counter) or AIFSN (Arbitration InterFrame Space Number; the unit time of communication waiting time). The QoS parameter 136 is set to a large value in advance as a specific example. By sending a beacon frame or a probe response frame with the QoS parameter 136 being set to a large value to the damaged CL 21, the waiting time until the damaged CL 21 sends a communication frame can be forcibly extended significantly. Setting the value of the QoS parameter 136 corresponds to tampering with the QoS parameter 136.

Furthermore, depending on the implementation of the damaged CL 21, a waiting time counter may be reset each time the damaged CL 21 receives a tampered beacon frame or probe response frame. In this case, it is possible to completely prevent the damaged CL 21 from communicating.

### ***Description of Operation***

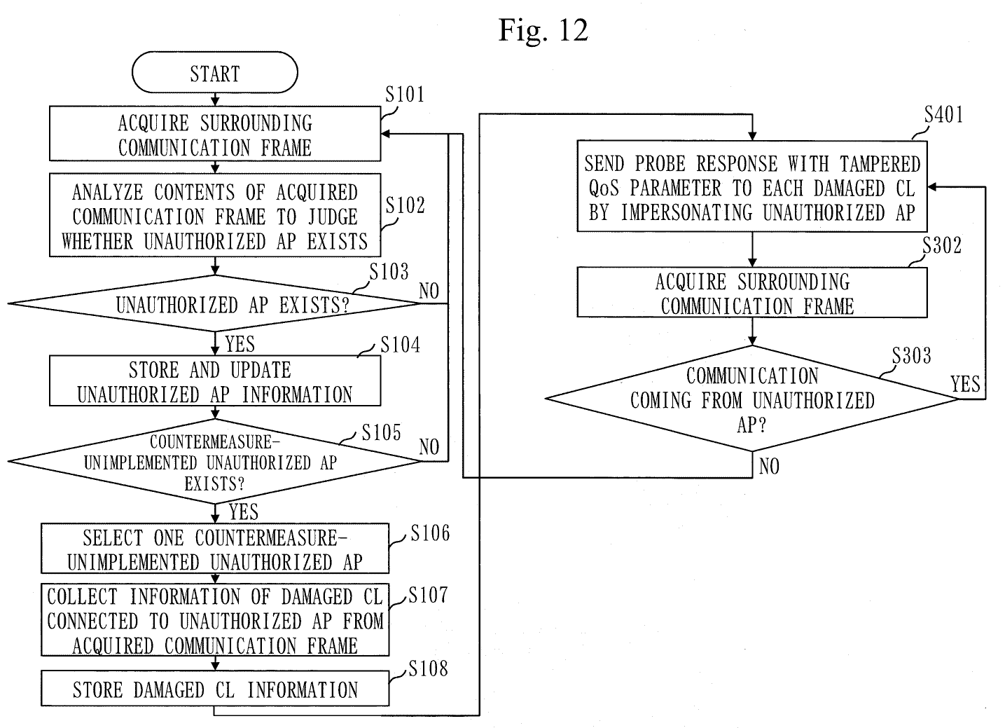

FIG. 12 is a flowchart showing an example of the operation of the monitoring device 100 according to Embodiment 4. FIG. 12 is used to describe the operation of the monitoring device 100.

### (Step S401)

The probe response generation unit 126 refers to the damaged device information 133 and sends a probe response frame with the QoS parameter 136 appropriately being set, to each damaged CL 21 indicated by the damaged device information 133 via a communication unit 110. At this time, the probe response generation unit 126 sets the transmission destination MAC address as the MAC address of each damaged CL 21. The probe response generation unit 126 may send a broadcast beacon frame instead of a probe response frame.

### ***Explanation of the Effects of Embodiment 4***

As described above, according to this Embodiment, by using the QoS parameter 136 to restrain communication of each damaged CL 21, it is possible to interfere with unauthorized communication between each damaged CL 21 and the unauthorized AP 10. Additionally, according to this Embodiment, it is possible to achieve effects similar to those of Embodiment 1.

### ***Other Configurations***

### <Modification 3>

Since Embodiment 4 is intended to extend the waiting time of the damaged CL 21, there is a risk that the damaged CL 21 may communicate with the unauthorized AP 10 once the waiting time has passed. Therefore, in this modification, a mode is shown where by utilizing the RTS/CTS (Request To Send/Clear To Send) method, which is one method of communication control, the damaged CL 21 is restrained from communicating.

The RTS/CTS method is a method where the AP assigns a transmission right to the CL to control communication. In the RTS/CTS method, the CL sends an RTS frame to the AP, and the AP responds to the RTS by specifying one CL with a CTS frame, allowing only the specified CL to send data to the AP. By using this mechanism, the CL to which a transmission right is assigned in the CTS frame is tampered with to a CL that does not exist in the surrounding device group, and by sending the tampered CTS frame, all the damaged CLs 21 can be restrained from transmitting.

It should be noted since this modification assumes that the RTS/CTS method is being used, it cannot always be applied to the monitoring device 100. However, many APs are equipped with a function to switch to the RTS/CTS method when communication quality deteriorates.

Below, the points different from Embodiment 4 are mainly described.

### ***Description of Configuration***

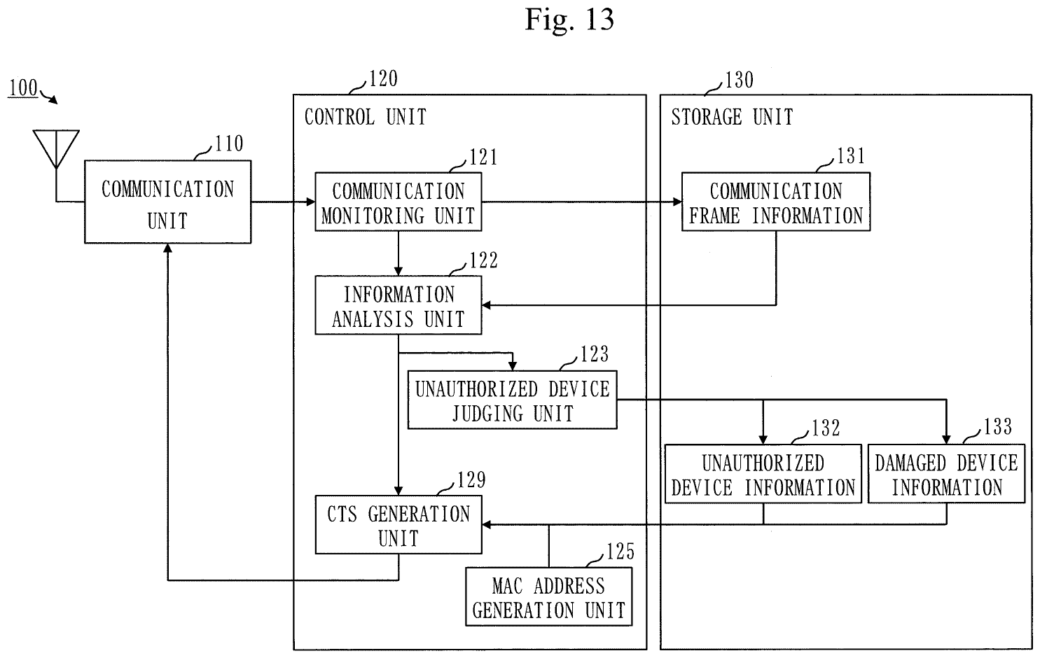

FIG. 13 shows an example configuration of a monitoring device 100 according to this modification.

A control unit 120 according to this modification, as shown in FIG. 13, is equipped with a CTS generation unit 129 and a MAC address generation unit 125 instead of a probe response generation unit 126.

The CTS generation unit 129 generates a CTS frame.

As a specific example, when the RTS/CTS method is used in a wireless communication network to which an unauthorized AP 10 and a damaged CL 21 are participating, the CTS generation unit 129 broadcasts data to the wireless communication network, the data including a communication frame in which device identification information different from device identification information of any device existing in the surrounding device group is set, as device identification information of a device to which a transmission right is to be assigned, in order to restrain the damaged CL 21 from communicating.

### ***Description of Operation***

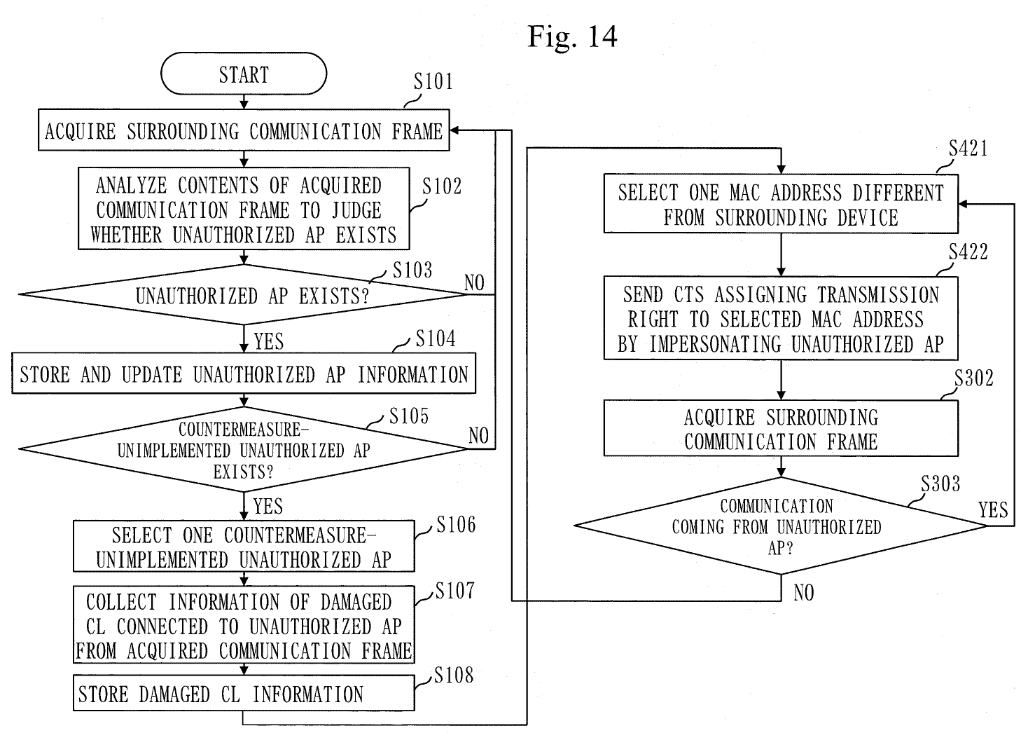

FIG. 14 is a flowchart showing an example of the operation of the monitoring device 100 according to this modification. FIG. 14 is used to describe the operation of the monitoring device 100.

### (Step S421)

The MAC address generation unit 125 generates one MAC address. The MAC address generation unit 125 may generate a MAC address using random numbers or by incrementing the value of the MAC address indicated by the damaged device information 133. The MAC address generation unit 125 refers to the damaged device information 133 and checks to ensure that the generated MAC address is different from any MAC address of the damaged CL 21 indicated by the damaged device information 133.

If the MAC address generation unit 125 confirms that the generated MAC address is different from any MAC address of the damaged CL 21 indicated by the damaged device information 133, the MAC address generation unit 125 sends data indicating the generated MAC address to the CTS generation unit 129. If the generated MAC address overlaps any MAC address of the damaged CL 21 indicated by the damaged device information 133, the MAC address generation unit 125 regenerates a MAC address and reconfirms that the newly generated MAC address is different from any MAC address of the damaged CL 21 indicated by the damaged device information 133.

### (Step S422)

First, the CTS generation unit 129 specifies the MAC address indicated by the data received from the MAC address generation unit 125, as the target of transmission right assignment.

Next, the CTS generation unit 129 generates a CTS frame with the transmission source MAC address being set as the MAC address of the unauthorized AP 10, and sends the generated CTS frame via broadcast to the LAN of the unauthorized AP 10 through the communication unit 110.

Additionally, the CTS generation unit 129 may unconditionally generate a CTS frame each time step S422 is executed and send the generated CTS frame each time the CTS frame is created. Furthermore, each time step S422 is executed, the communication monitoring unit 121 may reacquire the communication frames of the devices in the surrounding device group, and the CTS generation unit 129 may send the generated CTS frame only when the information analysis unit 122 confirms an RTS frame from the damaged CL 21 within the communication frames acquired by the communication monitoring unit 121.

### ***Explanation of the Effects of Modification 3***

As described above, according to this modification, by using the RTS/CTS method to restrain the damaged CL 21 from communication, it is possible to disrupt unauthorized communication between the damaged CL 21 and the unauthorized AP 10. Moreover, according to this modification, it is possible to achieve effects similar to those of Embodiment 1.

Additionally, in this modification, it is possible to restrain the damaged CL 21 from communication regardless of the waiting time of the damaged CL 21. Therefore, according to this modification, it is possible to mitigate damage more effectively compared to Embodiment 4.

### <Modification 4>

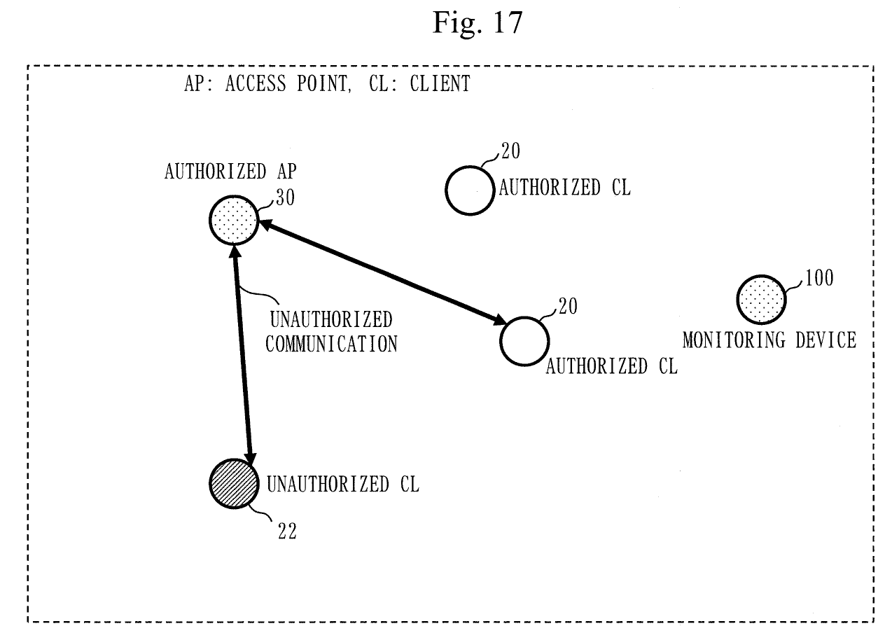

Embodiment 4 and Modification 3 are countermeasures against the unauthorized AP 10. However, as shown in FIG. 17, by swapping the roles between the access point and the client, a monitoring device 100 can impersonate an authorized AP 30 and restrain an unauthorized CL 22 from communication. In other words, by appropriately adapting the configurations of Embodiment 4 and Modification 3, it is also possible to execute countermeasures against the unauthorized CL 22.

Below, the case of adapting the configuration of Embodiment 4 will be described. It is assumed that an authorized AP 30 exists in the surrounding device group and that an unauthorized CL 22 is connected to the authorized AP 30.

A probe response generation unit 126 sends fifth transmission data to the unauthorized CL 22 to restrain the unauthorized CL 22 from communication. The fifth transmission data is communication data including: a communication frame in which device identification information of the authorized AP 30 is set as the source device identification information so that the monitoring device 100 is recognized as the authorized AP 30; and a communication frame in which either the QoS related field or the field related to communication control is set so that the waiting time taken until the unauthorized CL 22 sends the communication frame to the authorized AP 30 is not shorter than a second reference waiting time. The second reference waiting time may be defined in any manner.

Below, the case of adapting the configuration of Modification 3 will be described. It is assumed that an authorized AP 30 exists in a surrounding device group and that an unauthorized CL 22 is connected to the authorized AP 30.

When the authorized AP 30 and the unauthorized CL 22 are participating to a wireless communication network, the CTS generation unit 129, broadcasts data to the wireless communication network, the data including a communication frame in which device identification information different from device identification information of any device existing in the surrounding device group is set as the device identification information of the device to which a transmission right is to be assigned, in order to restrain the unauthorized CL 22 from communicating.

Additionally, in Patent Literature 1, there is an issue where an unauthorized client that can no longer communicate due to the update of the encryption key can relatively easily reconnect to an authorized access point by requiring reconnection to the authorized access point using the same MAC address, as performed by the WIPS monitoring device. According to this modification, the unauthorized client is restrained from requiring reconnection to the authorized access point, making it not easy to reconnect to the authorized access point.

### Embodiment 5

The following describes mainly the differences from the aforementioned Embodiments with reference to the drawings.

In Embodiment 2 and the modification of Embodiment 2, a method is adopted where the damaged CL 21 is once shifted to another channel to prevent communication with the damaged CL 21, requiring time until the damaged CL 21 resumes authorized communication. Therefore, in Embodiment 5, to mitigate damage more quickly and resume authorized communication sooner, a mode is shown where the monitoring device 100 directly seizes the communication connection with the damaged CL 21 from the unauthorized AP 10.

### ***Description of Configuration***

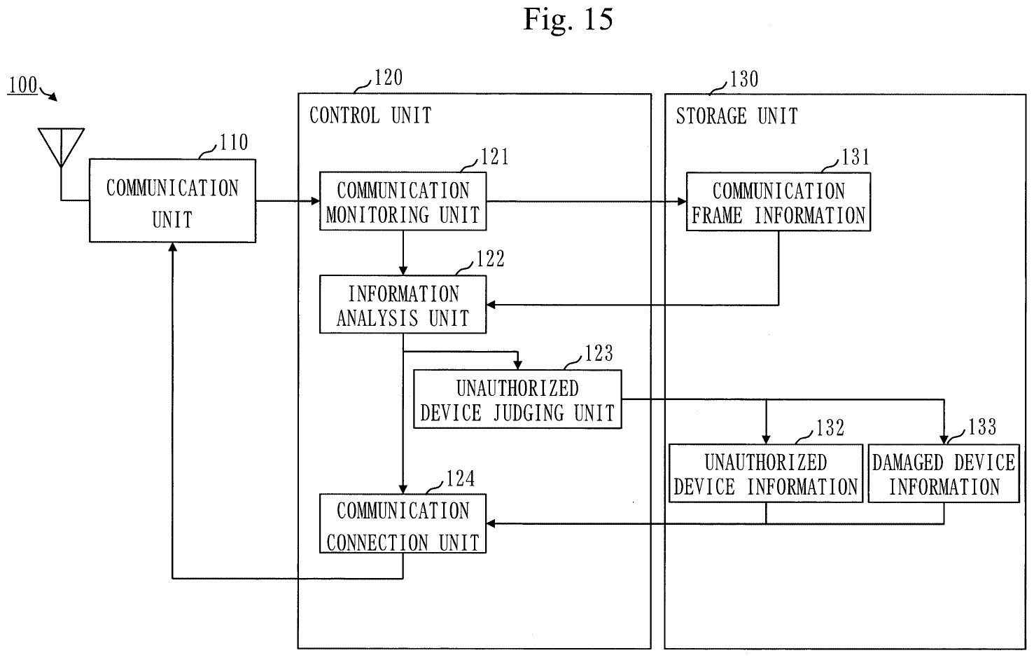

FIG. 15 shows a configuration example of a monitoring device 100 according to Embodiment 5.

The configuration of the monitoring device 100 is one in which the MAC address generation unit 125 and the used MAC address table 134 are excluded from the configuration of the monitoring device 100 according to Embodiment 1.

The communication connection unit 124 according to this Embodiment sends sixth transmission data to a damaged CL 21 to disconnect the communication connection between an unauthorized AP 10 and the damaged CL 21. The sixth transmission data is communication data including: a communication frame in which the device identification information of the unauthorized AP 10 is set as the source device identification information so that the monitoring device 100 is recognized as the unauthorized AP 10; a communication frame being set to disconnect communication connection between the unauthorized AP 10 and the damaged CL 21; and a communication frame being set to establish communication connection with the damaged CL 21.

### ***Description of Operation***

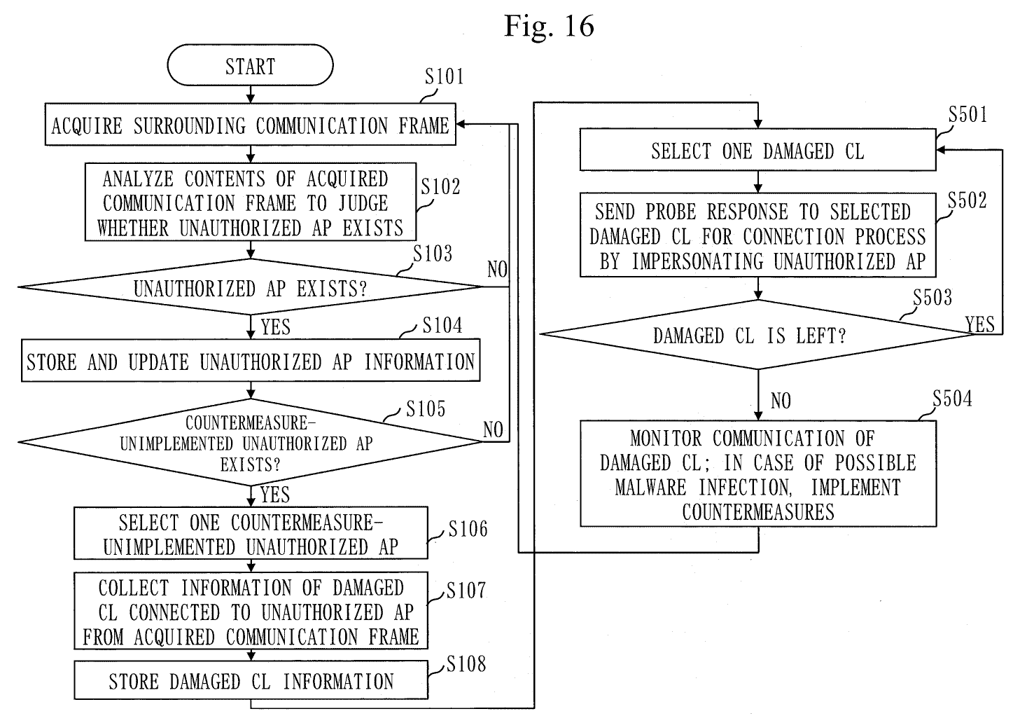

FIG. 16 is a flowchart showing an example of the operation of the monitoring device 100 according to Embodiment 5. FIG. 16 is used to describe the operation of the monitoring device 100.

### (Step S501)

The communication connection unit 124 refers to damaged device information 133 and selects one damaged CL 21 for which countermeasures have not been implemented. Hereinafter, the damaged CL 21 selected in step S501 is referred to as a third selected damaged CL.

### (Step S502)

The communication connection unit 124 sends a probe response frame in which the sender is the unauthorized AP 10′s MAC address and the transmission destination is the third selected damaged CL's MAC address, to the third selected damaged CL via a communication unit 110, thereby executing the connection process with respect to the third selected damaged CL.

The communication connection unit 124, after the connection process is successfully completed, sets a countermeasure implementation flag in the device information of the third selected damaged CL in the damaged device information 133.

### (Step S503)

If there is no device information in the damaged device information 133 where a countermeasure implementation flag is not set (that is, if a countermeasure implementation flag is set for all the damaged CLs 21 indicated by the damaged device information 133), the monitoring device 100 proceeds to step S504. Otherwise, the monitoring device 100 proceeds to step S501.

### (Step S504)

An unauthorized device judging unit 123 sets a countermeasure implementation flag in the device information of the selected unauthorized AP in an unauthorized device information 132, assuming that countermeasures have been implemented for the selected unauthorized AP.

Additionally, since each damaged CL 21 might have been forced to download malware due to communicating with the selected unauthorized AP until immediately recently, there is a possibility that each damaged CL 21 might send an attack frame to an authorized AP 30. Therefore, after the monitoring device 100 takes over the communication connection of each damaged CL 21, the authorized AP 30 may monitor the communication of each damaged CL 21 for a certain period and implement countermeasures as necessary. Specific examples of countermeasures include displaying a warning screen on each damaged CL 21, narrowing the communication bandwidth of each damaged CL 21, or ignoring communication from each damaged CL 21.

After the processing of step S504 is completed, the monitoring device 100 returns to step S101.

### ***Explanation of the Effects of Embodiment 5***

As described above, according to Embodiment 5, the monitoring device 100 can disconnect unauthorized communication between the unauthorized AP 10 and each damaged CL 21 by directly taking over the communication connection between the unauthorized AP 10 and each damaged CL 21. Additionally, according to this Embodiment, the same effects as those of Embodiment 1 can be obtained.

Furthermore, according to Embodiment 5, since the monitoring device 100 provides authorized communication to each damaged CL 21, it can provide authorized communication to each damaged CL 21 more quickly compared to Embodiment 2.

### ***Other Configurations***

### <Modification 5>

Embodiment 5 is a countermeasure against an unauthorized AP 10. However, as shown in FIG. 17, by swapping the roles between the access point and the client, the monitoring device 100 can also directly intercept communication from the authorized AP 30 to the unauthorized CL 22. In other words, by appropriately adapting the configuration of Embodiment 5, it is also possible to execute countermeasures against the unauthorized CL 22.

The following describes the adaptation of the configuration of Embodiment 5. It is assumed that an authorized AP 30 exists in a surrounding device group, and that an unauthorized CL 22 is connected to the authorized AP 30.

A communication connection unit 124 sends seventh transmission data to the unauthorized CL 22 to disconnect the communication connection between the authorized AP 30 and the unauthorized CL 22. The seventh transmission data is communication data including: a communication frame in which device identification information of the authorized AP 30 is set as source device identification information so that a monitoring device 100 is recognized as the authorized AP 30; a communication frame being set to disconnect communication connection between the authorized AP 30 and the unauthorized CL 22; and a communication frame being set to establish communication connection with the unauthorized CL 22.

Furthermore, according to this Modification, it is possible to solve the issues of the aforementioned Patent Literature 1.

### ***Other Embodiments***

It is possible to freely combine the previously described embodiments, modify any components of each embodiment, or omit any components in each embodiment.

Moreover, the embodiments are not limited to those shown as Embodiments 1 to 5, and various changes can be made as needed. The procedures described using flowcharts, etc., may be appropriately modified.

### Reference Signs List

10: unauthorized AP; 20: authorized CL; 21: damaged CL; 22: unauthorized CL; 30: authorized AP; 51: processor; 52: memory; 53: auxiliary storage device; 54: input/output IF; 55: communication device; 58: processing circuit; 59: signal line; 100: monitoring device; 110: communication unit; 120: control unit; 121: communication monitoring unit; 122: information analysis unit; 123: unauthorized device judging unit; 124: communication connection unit; 125: MAC address generation unit; 126: probe response generation unit; 127: channel selection unit; 128: deauthentication frame generation unit; 129: CTS generation unit; 130: storage unit; 131: communication frame information; 132: unauthorized device information; 133: damaged device information; 134: used MAC address table; 135: relation table; 136: QoS parameter.

1. A monitoring device comprising
processing circuitry
to repeatedly execute connection to an unauthorized access point when the unauthorized access point exists within a surrounding device group, in order to fill simultaneous connection slots of the unauthorized access point, using each device identification information from a device identification information group consisting of one or more pieces of device identification information generated not to overlap each other;
to connect to the unauthorized access point when the connection to the unauthorized access point fails, using device identification information of a damaged client being a communication device connected to the unauthorized access point, so as to disconnect communication connection between the unauthorized access point and the damaged client; and
to connect to the unauthorized access point using device identification information different from any device identification information in the device identification information group, in order to fill the simultaneous connection slots of the unauthorized access point that have become available due to disconnection of the communication connection,
the surrounding device group consisting of one or more devices that exist around the monitoring device and execute wireless communication,
each device identification information in the device identification information group being different from the device identification information of the damaged client.

2. The monitoring device according to claim 1,
wherein the processing circuitry judges whether the unauthorized access point exists within the surrounding device group based on a communication frame sent by each device in the surrounding device group.

3. The monitoring device according to claim 1, wherein each device identification information in the device identification information group is a MAC address, and the device identification information of the damaged client is a MAC address.

4. The monitoring device according to claim 1, wherein Protected Management Frames are enabled in wireless communication between the unauthorized access point and the damaged client.

5. The monitoring device according to claim 1
wherein the processing circuitry sends transmission data to the damaged client so as to switch a channel of the damaged client to a first channel, the transmission data being communication data including: a communication frame in which device identification information of the unauthorized access point is set as source device identification information so that the monitoring device is recognized as the unauthorized access point; and a communication frame in which the first channel, being a channel where the unauthorized access point does not exist, is set as a channel switching destination.

6. The monitoring device according to claim 5,
wherein when the monitoring device functions as an authorized access point,
the processing circuitry sends transmission data to a damaged client whose channel has been switched to the first channel, so as to switch the channel of the damaged client to a second channel, the transmission data being communication data including: a communication frame in which the device identification information of the unauthorized access point is set as the source device identification information so that the monitoring device is recognized as the unauthorized access point; and a communication frame in which the second channel, being a channel where the unauthorized access point does not exist, is set as a channel switching destination, and
wherein the processing circuitry switches a channel of the monitoring device to the second channel to establish authorized communication for the damaged client.

7. A monitoring method comprising
by a computer being a monitoring device,
repeatedly executing connection to an unauthorized access point when the unauthorized access point exists within a surrounding device group, in order to fill simultaneous connection slots of the unauthorized access point, using each device identification information from a device identification information group consisting of one or more pieces of device identification information generated not to overlap each other;
connecting to the unauthorized access point when the connection to the unauthorized access point fails, using device identification information of a damaged client being a communication device connected to the unauthorized access point, so as to disconnect communication connection between the unauthorized access point and the damaged client; and
connecting to the unauthorized access point using device identification information different from any device identification information in the device identification information group, in order to fill the simultaneous connection slots of the unauthorized access point that have become available due to disconnection of the communication connection,
the surrounding device group consisting of one or more devices that exist around the monitoring device and execute wireless communication,
each device identification information in the device identification information group being different from the device identification information of the damaged client.

8. A non-transitory computer readable medium recorded with a monitoring program which causes a monitoring device, being a computer, to execute a communication connection process comprising:
repeatedly executing connection to an unauthorized access point when the unauthorized access point exists within a surrounding device group, in order to fill simultaneous connection slots of the unauthorized access point, using each device identification information from a device identification information group consisting of one or more pieces of device identification information generated not to overlap each other;
connecting to the unauthorized access point when the connection to the unauthorized access point fails, using device identification information of a damaged client being a communication device connected to the unauthorized access point, so as to disconnect communication connection between the unauthorized access point and the damaged client; and
connecting to the unauthorized access point using device identification information different from any device identification information in the device identification information group, in order to fill the simultaneous connection slots of the unauthorized access point that have become available due to disconnection of the communication connection,
the surrounding device group consisting of one or more devices that exist around the monitoring device and execute wireless communication,
each device identification information in the device identification information group being different from the device identification information of the damaged client.
